(19) United States
(12) Patent Application Publication
(10) Pub. No.: US 2010/0205980 A1
(43) Pub. Date: Aug. 19, 2010

(54) REFRIGERANT LUBRICANT COMPOSITION

(75) Inventors: Elizabeth Dixon, Fareham (GB); Phil Beckler, The Woodlands, TX (US)

Correspondence Address: CONLEY ROSE, P.C.;David A. Rose, P. O. BOX 3267, HOUSTON, TX, 77253-3267, US

(73) Assignee: SHRIEVE CHEMICAL PRODUCTS, INC., The Woodlands, TX (US)

(21) Appl. No.: 12/637,542

(22) Filed: Dec. 14, 2009

Related U.S. Application Data
(60) Provisional application No. 61/140,554, filed on Dec. 23, 2008.

(51) Int. Cl. F25D 3/12; C10M 107/34; C10M 129/40; C10M 133/12; C10M 133/44; C10M 137/04; C10M 169/04; C09K 5/04

(52) U.S. Cl. 62/56; 508/579; 508/526; 508/563; 508/280; 508/441; 508/304; 252/68

(57) ABSTRACT

A PAG lubricant basefluid for use with a fluoroalkene refrigerant, the basefluid containing a PAG having the formula: RX(R^{a}O)ₓ(R^{b}O)_{y}R^{c}, where R is selected from alkyl groups having from 1-10 carbon atoms, acyl groups having from 1-10 carbon atoms, aliphatic hydrocarbon groups having from 2-6 valencies, and substituents containing a heterocyclic ring in which the heteroatom(s) are oxygen; X is O or S; R^{a} is a C2 alkylene group; R^{b} is a C3 alkylene group; R^{c} is the same as R or is an H; x and y are each independently 0 or an integer≦100; and the sum of x+y is an integer in the range of from about 5-100. Refrigeration and lubricant compositions containing the PAG lubricant basefluid and a method of operating a motor-integrated compressor of a refrigeration or air conditioning system with substantially no electrical leakage current are also provided.

### CROSS-REFERENCE TO RELATED APPLICATIONS

This application claims the benefit under 35 U.S.C. §119(e) of U.S. Provisional Patent Application Ser. No. 61/140,554 filed Dec. 23, 2008, which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

This invention relates to lubricants for synthetic refrigerants. More specifically, this invention relates to lubricants suitable for use with fluoroalkene refrigerants, such as HFO-1234yf refrigerant. Still more specifically, this invention relates to lubricants suitable for use in motor-integrated compressors of refrigeration/air-conditioning systems.

2. Background of the Invention

The dominant refrigerant utilized in automotive air conditioning systems has been the hydrofluorocarbon (HFC) known as HFC r134a (1,1,1,2-tetrafluoroethane). European legislation mandates abolition of the use of HFC r134a refrigerant in new mobile (automotive) air-conditioning systems effective in model year 2011. As a result of this mandate, various other refrigerants, including hydrofluoro-olefin (HFO) refrigerants such as HFO-1234yf, having chemical composition 2,3,3,3-tetrafluoroprop-1-ene, are under active development as more environmentally-friendly refrigerants for use in automotive air-conditioning systems. However, refrigerants of the chemical type of HFO-1234yf require a lubricant enabling implementation with traditional automotive air-conditioning systems. Such a refrigeration lubricant offering properties specific to this type of refrigerant must exhibit appropriate miscibility, chemical, thermal and hydrolytic stability, and appropriate pressure, viscosity and temperature dynamics when combined therewith.

With an increasing industry focus on utilizing hybrid and electric air-conditioning compressors to realize vehicle fuel savings, there is a further desire that the lubricant technology developed for belt-driven compressors (e.g. belt-driven HFO-1234yf compressors) be applicable for use in electrically driven compressors, where the electrical properties of the lubricant require careful consideration.

Organic polyalkylene glycol (PAG) lubricants are known, for example, as taught in U.S. Patent App. No. 2007/0069175 to Honeywell. U.S. Patent App. No. 2007/0069175 teaches mixtures of various fluoroalkenes with a variety of lubricants, including organic lubricants of the polyalkylene glycol (PAG) type. U.S. Patent App. No. 2007/0069175 does not teach the suitability of one structural type of lubricant relative to another. Additionally, the disclosure does not address the significant impact on system stability of fluoroalkene type refrigerants and the modifications therefore required from the lubricant perspective with respect to additive technology commonly utilized to provide corrosion prevention, thermal stability, and improved lubricity in refrigeration and air conditioning systems.

The use of PAG-type lubricants in motor-integrated compressors of refrigeration/air conditioning systems is discussed in Japanese Pat. No. JP04015295A to Idemitsu. JP04015295A describes the use of anion and/or cation exchange resins for the purification of certain types of PAGs.

Accordingly, there is a need in the industry for lubricants suitable for use with HFO refrigerants, particularly for use with HFO-1234yf, and for lubricants suitable for use in motor-integrated compression-type refrigeration/air conditioning systems.

### SUMMARY

A polyalkylene glycol lubricant basefluid for use with a fluoroalkene refrigerant, the polyalkylene glycol lubricant basefluid comprising a PAG having the formula: RX(R^{a}O)ₓ(R^{b}O)_{y}R^{c}, wherein: R is selected from the group consisting of alkyl groups having from 1 to 10 carbon atoms, acyl groups having from 1 to 10 carbon atoms, aliphatic hydrocarbon groups having from 2 to 6 valencies, and substituents comprising a heterocyclic ring in which the one or more heteroatoms are oxygen; X is selected from the group consisting of O and S; R^{a} is a C2 alkylene group; R^{b} is a C3 alkylene group; R^{c} is the same as R or is an H; x and y are each independently 0 or an integer less than or equal to 100; and the sum of x+y is an integer in the range of from about 5 to about 100. In embodiments, x equals zero, the polyalkylene glycol lubricant being suitable for use in conjunction with fluoroalkene refrigerant in refrigeration/air-conditioning systems and comprising a PAG having the formula: RX(R^{b}O)_{y}R^{c}, wherein R is selected from the group consisting of alkyl groups containing from 1 to 10 carbon atoms and aliphatic hydrocarbons; X is an oxygen atom; R^{b} is selected from the group consisting of alkylene groups containing 3 carbon atoms; R^{c} is selected from the group consisting of alkyl groups containing from 1 to 10 carbon atoms and aliphatic hydrocarbons; and y is an integer in the range of from about 5 to about 100. In embodiments, R, R^{c} or both are selected from alkyl groups containing from 1 to 3 carbon atoms. The polyalkylene glycol lubricant basefluid may have a kinematic viscosity of at least 30 cSt. The polyalkylene glycol lubricant basefluid may have a viscosity index of at least 150. In embodiments, the polyalkylene glycol lubricant basefluid is suitable for use in conjunction with fluoroalkene refrigerants in motor-integrated compression type refrigeration and air conditioning systems and, as a result of purification techniques applied to the polyalkylene glycol, the polyalkylene glycol lubricant basefluid demonstrates a Total Acid Value of less than 0.03 mgKOH/g, a cation content of less than 30 ppm and a moisture content of less than 300 ppm. Such a polyalkylene glycol lubricant basefluid may have electrical properties desirable to ensure substantially no electrical leakage current is observed in motor-integrated compressors, exhibiting a minimum volume resistivity at 20° C. of 1×10¹² ohm cm.

Also disclosed herein is a lubricant composition for use in conjunction with fluoroalkene refrigerant in refrigeration/air conditioning systems, the lubricant composition comprising at least one additive and a PAG having the formula: RX(R^{b}O)_{y}R^{c}, wherein R is selected from the group consisting of alkyl groups containing from 1 to 10 carbon atoms and aliphatic hydrocarbons; X is an oxygen atom; R^{b} is selected from the group consisting of alkylene groups containing 3 carbon atoms; R^{c} is selected from the group consisting of alkyl groups containing from 1 to 10 carbon atoms and aliphatic hydrocarbons; and y is an integer in the range of from about 5 to about 100. In embodiments, the at least one additive is selected from antiwear or extreme pressure additives, antioxidants, corrosion inhibitors and acid scavengers. In embodiments, the lubricant composition comprises at least one antioxidant selected from the group consisting of benzenepropanoic acid, 3,5-bis(1,1-dimethyl-100% ethyl)-4-hydroxy, C7-C9 branched alkyl esters, and benzenamine, N-phenyl, reaction products with 2,4,4-trimethylpentene. In embodiments, the lubricant composition comprises at least one corrosion inhibitor selected from the group consisting of isomeric mixtures of N,N-bis(2-ethylhexyl)-4-methyl-1H-benzotriazole-1-methylamine and N,N-bis(2-ethylhexyl)-5-methyl-1H-benzotriazole-1-methaylamine. In embodiments, the lubricant composition comprises an extreme pressure or antiwear additive selected from the group consisting of C11-14-branched alkyl amines, monohexyl and dihexyl phosphates. In embodiments, the lubricant composition comprises an acid scavenger comprising an epoxide functionality.

Also disclosed herein is a working fluid composition for use in a compression refrigeration, air conditioning or heat pump system, the working fluid composition comprising: a fluoroalkene containing 3 or 4 carbon atoms and at least one but no more than 2 double bonds; and an effective amount of lubricant to provide lubrication so that a mixture comprising the fluoroalkene and up to 10 wt % of the lubricant maintains one liquid phase at all temperatures in the range of from −60° C. to +29.5° C., wherein said lubricant wholly or partly comprises the a polyalkylene glycol lubricant basefluid comprising a PAG having the formula: RX(R^{b}O)_{y}R^{c}, wherein R is selected from the group consisting of alkyl groups containing from 1 to 10 carbon atoms and aliphatic hydrocarbons; X is an oxygen atom; R^{b} is selected from the group consisting of alkylene groups containing 3 carbon atoms; R^{c} is selected from the group consisting of alkyl groups containing from 1 to 10 carbon atoms and aliphatic hydrocarbons; and y is an integer in the range of from about 5 to about 100. In embodiments, the working fluid composition comprises an effective amount of lubricant to provide lubrication so that a mixture comprising the fluoroalkene and up to 50 wt % of the lubricant maintains one liquid phase at all temperatures in the range of from −60° C. to +29.5° C.

Also disclosed herein is a polyalkylene glycol based lubricant composition for use in motor-integrated compression type refrigeration/air conditioning systems, the polyalkylene based lubricant composition comprising a polyalkylene glycol lubricant basefluid comprising a PAG having the formula: RX(R^{a}O)ₓ(R^{b}O)_{y}R^{c}, wherein: R is selected from the group consisting of alkyl groups having from 1 to 10 carbon atoms, acyl groups having from 1 to 10 carbon atoms, aliphatic hydrocarbon groups having from 2 to 6 valencies, and substituents comprising a heterocyclic ring in which the one or more heteroatoms are oxygen; X is selected from the group consisting of O and S; R^{a} is a C2 alkylene group; R^{b} is a C3 alkylene group; R^{c} is the same as R or is an H; x and y are each independently 0 or an integer less than or equal to 100; and the sum of x+y is an integer in the range of from about 5 to about 100; wherein the polyalkylene glycol has been purified such that the purified polyalkylene glycol has a Total Acid Value of less than 0.03 mgKOH/g, a cation content of less than 30 ppm and a moisture content of less than 300 ppm and exhibits a minimum volume resistivity at 20° C. of 1×10¹² ohm cm, such that the lubricant exhibits substantially no electrical leakage current in motor-integrated compressors. Also disclosed is a working composition comprising: a refrigerant selected from the group consisting of carbon dioxide (R744) and fluorocarbon 1,1,1,2-tetrafluoroethane (R134a); and such a polyalkylene glycol based lubricant composition.

Also disclosed herein is a polyalkylene glycol lubricant basefluid suitable for use with fluoroalkene refrigerants in refrigeration or air-conditioning systems, the polyalkylene glycol lubricant basefluid comprising a homopolymer of oxypropylene terminated by simple alkoxy groups containing from 1 to 10 carbon atoms. In embodiments, the homopolymer of oxypropylene is terminated by at least one methoxy group. In embodiments, each end of the homopolymer of oxypropylene is terminated by a methoxy group. In embodiments, the polyalkylene glycol lubricant basefluid comprising a homopolymer of oxypropylene terminated by simple alkoxy groups containing from 1 to 10 carbon atoms comprises from about 5 to about 100 oxypropylene units and has a kinematic viscosity of at least 30 cSt and a viscosity index of at least 150. Also disclosed is a lubricant composition suitable for use with fluoroalkene refrigerants in motor-integrated compression type refrigeration or air conditioning systems, the lubricant composition comprising a homopolymer of oxypropylene terminated by simple alkoxy groups containing from 1 to 10 carbon atoms; and demonstrating a Total Acid Value of less than about 0.03 mgKOH/g, a cation content of less than about 30 ppm and a moisture content of less than about 300 ppm. Such a lubricant composition may exhibit a minimum volume resistivity at 20° C. of at least 1×10¹² ohm cm.

Also disclosed herein is a lubricant composition for use in conjunction with fluoroalkene refrigerant in refrigeration/air conditioning systems, the lubricant composition comprising a homopolymer of oxypropylene terminated by simple alkoxy groups containing from 1 to 10 carbon atoms; and at least one additive selected from the group consisting of benzenepropanoic acid, 3,5-bis(1,1-dimethyl-100% ethyl)-4-hydroxy, C7-C9 branched alkyl esters, benzenamine, N-phenyl, reaction products with 2,4,4-trimethylpentene, isomeric mixtures of N,N-bis(2-ethylhexyl)-4-methyl-1H-benzotriazole-1-methylamine and N,N-bis(2-ethylhexyl)-5-methyl-1H-benzotriazole-1-methylamine, C11-14-branched alkyl amines, monohexyl and dihexyl phosphates and acid scavengers comprising an epoxide functionality.

Also disclosed herein is a working fluid composition for use in compression refrigeration, air conditioning and heat pump systems comprising: a fluoroalkene containing from 3 to 4 carbon atoms and at least one but no more than 2 double bonds; and an effective amount of a lubricant composition to provide lubrication such that a mixture comprising the fluoroalkene and up to 50 wt % of the lubricant composition exhibits a single liquid phase at all temperatures between −60 and +29.5° C., said lubricant composition wholly or partly comprising a polyalkylene glycol lubricant basefluid comprising a homopolymer of oxypropylene terminated by simple alkoxy groups containing from 1 to 10 carbon atoms.

Also disclosed is a polyalkylene glycol based lubricant composition for use in motor-integrated compression type refrigeration and air conditioning systems with a refrigerant selected from the group consisting of carbon dioxide (R744) and fluorocarbon 1,1,1,2-tetrafluoroethane (R134a), the polyalkylene glycol based lubricant composition comprising a polyalkylene glycol purified such that the polyalkylene glycol based lubricant composition demonstrates a Total Acid Value of less than about 0.03 mgKOH/g, a cation content of less than about 30 ppm and a moisture content of less than about 300 ppm and exhibits a minimum volume resistivity at 20° C. of at least 1×10¹² ohm cm. Also disclosed is a method of operating a motor-integrated compressor of a refrigeration or air conditioning system with substantially no electrical leakage current, the method comprising: operating the compressor with a working fluid composition comprising a refrigerant and such a polyalkylene glycol based lubricant composition.

Thus, embodiments described herein comprise a combination of features and advantages intended to address various shortcomings associated with certain prior art lubricants. The various characteristics described above, as well as other features, will be readily apparent to those skilled in the art upon reading the following detailed description of the various embodiments, viewing the figures and examining the claims.

### BRIEF DESCRIPTION OF THE DRAWINGS

For a more detailed description of various embodiments of the present invention, reference will now be made to the accompanying drawings, wherein:

FIG. 1 is a plot of volume resistivity (in Ωcm) as a function of moisture content for a PAG based lubricant according to an embodiment of this disclosure.

FIG. 2 is a plot of volume resistivity (in Ωcm) as a function of Total Acid Value for a PAG based lubricant according to an embodiment of this disclosure.

### NOTATION AND NOMENCLATURE

Unless otherwise noted, the terms ‘basefluid,’ ‘lubricant’ and ‘lubricant oil’ are used interchangeably herein.

Use of the notation C1, C2, C3, and so on is intended to represent functional groups containing the indicated number of carbon atoms. That is, C1 groups contain 1 carbon atom, C2 groups contain 2 carbon atoms, C3 groups contain 3 carbon atoms, and so on.

Use of the phrase ‘refrigeration/air-conditioning’ is intended to mean ‘refrigeration, air-conditioning or both.’

Use of the phrase ‘extreme pressure/antiwear additives’ is intended to mean ‘extreme pressure additives, antiwear additives, additives that serve as both extreme pressure and antiwear additives, or combinations of extreme pressure additives and antiwear additives.’

A ‘working fluid composition’ may at times be referred to herein as a ‘working fluid composition.’

### DETAILED DESCRIPTION

Herein disclosed are basefluids of a type suitable for use in fluoroalkene (e.g. HFO-1234yf) refrigeration and air conditioning systems and/or for use with motor-integrated compressors, refrigeration and lubricant compositions comprising the basefluid and methods of preparing lubricant and refrigeration compositions comprising the basefluid. In embodiments, the basefluid is combined with additive componentry designed to offer an optimized balance of properties desirable for use in HFO (e.g. HFO-1234yf) refrigeration and air-conditioning systems. In embodiments, a basefluid is provided of a sufficient purity that it provides desirable electrical properties for application of the lubricant in motor-integrated compressors (e.g., automotive, electrically driven compressors). The high purity basefluid may be operable with HFO or alternate refrigerants. In such applications, the lubricant composition retains electrical properties required for application where lubricant is in direct contact with motor windings.

Basefluid. The basefluid of this disclosure comprises a polyalkylene glycol. In embodiments, the PAG basefluid is suitable for use with or is purified such that it is suitable for use in motor-integrated compressors. In embodiments, the PAG basefluid is suitable for use with fluoroalkene refrigerants, such as HFO-1234yf refrigerant.

In embodiments, a PAG basefluid comprises a polyalkylene glycol having the formula represented by Eq. (1).

RX(R^{a}O)ₓ(R^{b}O)_{y}R^{c} (1)

wherein: R is selected from alkyl groups having from 1 to 10 carbon atoms, acyl groups having from 1 to 10 carbon atoms, aliphatic hydrocarbon groups having from 2 to 6 valencies, and substituents comprising a heterocyclic ring in which the heteroatom(s) is (are) oxygen; X is selected from O and S; R^{a} is a C2 alkylene group; R^{b} is a C3 alkylene group; R^{c} is the same as R, or is an H; x and y are each independently 0 or an integer less than or equal to 100; and the sum of x+y is an integer in the range of from 5 to 100. In embodiments, X is O. In embodiments, R functionalities do not include a hydrogen atom, H, or heteroatoms. Aliphatic hydrocarbon groups include, but are not limited to, alkanes, alkenes, or alkynes. Examples, of suitable aliphatic hydrocarbons include methyl, butyl, and propyl. In embodiments, the basefluid is a homopolymer of oxypropylene.

In embodiments, the basefluid is miscible with the HFO refrigerant HFO-1234yf, as will be further discussed hereinbelow. In such embodiments, the basefluid comprises a di-alkoxy terminated polyalkylene glycol. In embodiments, one or more of the alkoxy terminations is a methoxy functionality. In embodiments, both alkoxy terminations are methoxy functionalities. In embodiments, the polyalkylene glycol is a straight chain polyalkylene glycol. In embodiments, the polyalkylene glycol is a homopolymer of oxypropylene. Heteropolymers containing oxyethylene in addition to oxypropylene are less desirable for use with HFO-1234yf, as are polyalkylene glycols having terminal hydroxyl groups, although these PAGs may be suitable for other fluoroalkenes. Thus, in embodiments, neither of the alkoxy terminal groups is a hydroxyl group and the polyalkylene glycol does not comprise oxyethylene (i.e., does not comprise a heteropolymer containing oxypropylene).

A PAG lubricant basefluid suitable for use with fluoroalkenes, including HFO-1234yf, has the formula of Eq. (1) wherein x is 0. In such embodiments, the basefluid has the structural type represented by the formula in Eq. (2):

RX(R^{b}O)_{y}R^{c} (2)

In embodiments, the basefluid has the formula represented by Eq. (2) and R is selected from C1-C10 alkyl groups and aliphatic hydrocarbon groups; X is O; R^{b} is a C3 alkylene group; R^{c} is the same as R or an alternate C1-C10 alkyl group or aliphatic hydrocarbon; and y is an integer in the range of from 5 to 100. In embodiments, R is a C1 alkyl group. In embodiments, R is a C1 alkyl group and R^{c} is also a C1 alkyl group or an alternate C2-C10 alkyl group or aliphatic hydrocarbon. In these embodiments, R functionalities do not include a hydrogen atom, H, or heteroatoms.

In embodiments, the lubricating oil basefluid is or has been subjected to further purification procedures whereby the lubricant exhibits a volume resistivity at 20° C. of at least 1×10¹² ohm cm. In embodiments, the polyalkylene glycol is purified with cation and/or anion exchange techniques to offer minimized levels of either or both acid or alkali metal catalyst. In embodiments, the basefluid is provided at or purified such that the Total Acid Value of the basefluid is less than about 0.03 mgKOH/g, less than about 0.02 mgKOH/g, or less than about 0.01 mgKOH/g. In embodiments, the basefluid is provided at or purified such that the cation content of the purified basefluid is less than about 30 ppm, less than about 20 ppm, or less than about 10 ppm.

The polyalkylene glycol may also be dried via enhanced drying techniques to reduce the moisture content of the basefluid to values typically lower then previously utilized for PAG lubricants in refrigeration/air conditioning systems. In embodiments, the basefluid is a polyalkylene glycol that is provided at or dried to a moisture content of less than about 300 ppm, less than about 200 ppm, or less than about 100 ppm.

In embodiments, the lubricant basefluid or lubricant composition has a kinematic viscosity of at least 30 cSt at 40° C., at least 20 cSt at 40° C., or at least 10 cSt at 40° C. and/or a viscosity index of at least 150, at least 120, or at least 100. In embodiments, the lubricant basefluid or lubricant composition when added to a refrigerant, at a concentration of at most 50 wt %, retains a one liquid phase at temperatures between about −60° C. and about 30° C., between about −75° C. and about 75° C., and/or between about −100° C. to about 100° C. In embodiments, the lubricant basefluid or lubricant composition when added to a fluoroalkene refrigerant (e.g. HFO 1234yf refrigerant), at a concentration of at most 50 wt %, retains a one liquid phase at temperatures between about −40° C. and about 10° C., between −50° C. and about 20° C., and/or between −60° C. and about 30° C.

Lubricant Composition. The lubricating oil or basefluid may be used in combination with additives, such as extreme pressure additives, antiwear additives, antioxidants, and anti-corrosion additives, antifoam additives, acidity regulators and water-eliminating additives.

Herein disclosed are compositions comprising a basefluid as described above with one or more additives. It has been determined that the incorporation of certain additives with the disclosed polyalkylene glycol basefluid offers performance benefits with respect to the functionalities of the additives, without compromising aspects of lubricant performance in refrigeration and air conditioning systems which are commonly associated with additisation for cooling, air-conditioning, and refrigeration systems. In embodiments, a lubricating composition comprises a lubricant basefluid as described in Eqs. (1) or (2) in conjunction with one or more additives. In embodiments, the one or more additives are selected from the groups listed hereinafter. Although the additives disclosed herein may be particularly desirable additives for use with the disclosed basefluid, the listing is not exclusive, and other additives known to one skilled in the art may alternatively or additionally be suitable. Appropriate selection, combination, and/or concentration of one or more additives with the basefluid may provide optimized levels of lubricant and refrigerant performance, with respect to corrosion and pressure derived wear within the system, without compromising the chemical and/or thermal stability of the refrigerant.

In embodiments, the lubricant composition comprises from about 1.0% to about 10.0 wt % additives, from about 2.0 wt % to about 6.0 wt % additives or from about 3.0 wt % to about 5.0 wt % additives. In embodiments, the refrigeration composition comprises less than about 2.5 wt %, 2.0 wt %, 1.5 wt %, 1.0 wt %, 0.5 wt % or 0.25 wt % additive(s).

In embodiments, a lubricating composition comprises one or more antioxidants. In embodiments, the one or more antioxidants are selected from antioxidants of the common phenolic and aminic types associated with lubricating oils compositions, including, but not limited to, those including benzenepropanoic acid, 3,5-bis(1,1-dimethyl-100% ethyl)-4-hydroxy, branched alkyl esters, and benzenamine, N-phenyl, reaction products with 2,4,4-trimethylpentene. In embodiments, the branched alkyl esters comprise 6-carbon (C6) to 12-carbon (C12) esters, 7-carbon (C7) to 12-carbon (C12) esters, or 7-carbon (C7) to 9-carbon esters (C9). In certain instances, more than one antioxidant may be utilized in the basefluid to obtain synergistic anti-oxidancy effect known to those skilled in the art of inhibiting oxidation tendency in this basefluid type. A lubricating composition or refrigeration composition according to this disclosure may comprise from about 0 wt % to about 4.0 wt % antioxidants, from about 0.1 to about 2.0 wt % antioxidants, or from about 0.2 to about 0.8 wt % antioxidants.

In embodiments, a lubricating composition further comprises one or more corrosion inhibitors. In embodiments, one or more corrosion inhibitors are selected from isomeric mixtures of N,N-bis(2-ethylhexyl)-4-methyl-1H-benzotriazole-1-methylamine and N,N-bis(2-ethylhexyl)-5-methyl-1H-benzotriazole-1-methylamine. A lubricating composition or refrigeration composition according to this disclosure may comprise from about 0.01 to about 1.0 wt % corrosion inhibitors, from about 0.01 to about 0.5 wt % corrosion inhibitors, or from about 0.05 to about 0.15 wt % corrosion inhibitors.

In embodiments, a lubricating composition comprises one or more extreme pressure/antiwear additives. In embodiments, the one or more extreme pressure/antiwear additives are selected from the sulfur and/or phosphorous containing types commonly associated with lubricating oil compositions, including, but not limited to, the group consisting of branched alkyl amines, monohexyl and dihexyl phosphates. In embodiments, the extreme pressure/antiwear additive comprises branched alkyl amine phosphates with a 5-carbon (5C) to 20-carbon (20C) structure (i.e. containing from 5 to 20 carbon atoms), a 10-carbon (10C) to 15-carbon (15C) structure, or a 11-carbon (11C) to 14-carbon (14C) structure. A lubricating composition or refrigeration composition according to this disclosure may comprise from about 0.01 wt % to about 1.0 wt % extreme pressure/antiwear additives, from about 0.01 wt % to about 0.5 wt % extreme pressure/antiwear additives, or from about 0.05 wt % to about 0.15 wt % extreme pressure/antiwear additives.

As mentioned, in embodiments, a lubricating composition further comprises one or more acidity regulators. Suitable acidity regulators include, but are not limited to, those containing an epoxide functionality.

The preferred combination and dosage of additives with polyalkylene glycol lubricant basefluid provides optimized levels of additive performance with respect to corrosion prevention and lubricity enhancement, without compromise of system chemical and thermal stability which may be observed with alternate selection of additives.

Refrigerant Composition. Herein disclosed are refrigerant compositions comprising a PAG-based lubricant basefluid as described hereinabove and a refrigerant. Desirably, the refrigeration composition also comprises one or more additives as discussed hereinabove. In embodiments, the refrigeration composition comprises a fluoroalkene refrigerant. In embodiments, the fluoroalkene comprises 3 or 4 carbon atoms and at least one but no more than two double bonds. In embodiments, the refrigeration composition comprises a refrigerant selected from 1,2,3,3-tetrafluoropropene, 2,3,3,3-tetrafluoropropene, 1,3,3,3-tetrafluoropropene, 3,3,3-trifluoropropene and 1,2,3,3,3-pentafluoropropene. In embodiments, the refrigeration composition comprises the HFO refrigerant HFO-1234yf. In embodiments, a refrigeration composition of this disclosure comprises HFO-1234yf. In embodiments, a refrigeration composition of this disclosure comprises R744. In embodiments, a refrigeration composition of this disclosure comprises R134a.

In embodiments, the lubricant comprises a PAG as represented by Eq. (1) and the lubricant exhibits substantially no electrical leakage current in motor-integrated compressors. In embodiments, the lubricant comprises a PAG as represented by Eq. (2) and the lubricant is suitable for use with fluoroalkene refrigerant in refrigeration/air conditioning systems. In embodiments, the lubricant comprises a PAG as represented by Eq. (2) and the lubricant is suitable for use in compression refrigeration, air conditioning and heat pump systems.

In embodiments, the refrigeration composition comprises from about 0 wt % to about 100 wt % lubricant basefluid, from about 0 wt % to about 80 wt % lubricant basefluid, or from about 0 wt % to about 50 wt % lubricant basefluid. In embodiments, the refrigeration composition comprises less than about 50 wt %, 40 wt %, 30 wt %, 20 wt %, 10 wt % or 5 wt % lubricant basefluid. In embodiments, the refrigeration composition further comprises from about 0 wt % to about 10 wt % additives, from about 0 wt % to about 5 wt % additives, or from about 0 wt % to about 2.5 wt % additives. In embodiments, the refrigeration composition comprises less than about 2.5 wt %, 2.0 wt %, 1.5 wt %, 1 wt %, 0.5 wt % or 0.25 wt % additives.

Method of Providing Lubricant. As mentioned hereinabove, herein disclosed is a method of preparing a polyalkylene glycol based lubricant. The method comprises purifying the lubricant via an anion/cation exchange process and moisture removal techniques whereby desirable lubricant properties are obtained. Desirable lubricant properties may include desired values of one or more property selected from total acid value, moisture content, electrical resistivity and combinations thereof.

In embodiments, purifying the lubricating oil produces a purified lubricant having a volume resistivity at 20° C. of at least 1×10¹² ohm cm. Volume resistivities exceeding 1×10¹² ohm cm may be achieved by a combination of catalyst and moisture removal techniques. Specifically, such purification can comprise ion exchange techniques and/or controlled moisture removal using a combination of controlled heating and vacuum techniques. Application of such purification techniques to a PAG lubricant for application with HFO-1234yf refrigerant may enable a single product of ultra-pure quality (i.e., a cation content of less than 30 ppm, a moisture content of less than 300 ppm and/or a Total Acid Value of less than 0.03 mgKOH/g) to be adopted for use in both motor-integrated and non-motor-integrated HFO-1234yf refrigeration and air-conditioning systems. Furthermore, adoption of such purification techniques to similar polyalkylene glycols used in conjunction with alternate refrigerants, including HFC types such as r134a and alternate refrigerants such as r744, which is being proposed as an environmentally friendly refrigerant for use in automotive air-conditioning systems, may allow utilization of PAG lubricants for motor-integrated compressors of these refrigeration/air conditioning systems.

In embodiments, purifying the polyalkylene glycol basefluid with cation and/or anion exchange techniques provides minimized levels of either or both acid or alkali metal catalyst. In embodiments, purifying the basefluid provides a basefluid having a Total Acid Value of less than about 0.03 mgKOH/g, less than about 0.02 mgKOH/g, or less than about 0.01 mgKOH/g. In embodiments, the method comprises purifying the basefluid such that the cation content of the purified basefluid is less than about 30 ppm, less than about 20 ppm, or less than about 10 ppm.

Preparing a PAG-based lubricant may further comprise drying a polyalkylene glycol comprising basefluid via enhanced drying techniques to reduce the moisture content of the basefluid to values typically lower then previously utilized for PAG lubricants in refrigeration/air conditioning systems. In embodiments, drying comprises removing moisture from the lubricant such that the moisture content of the dried basefluid is less than about 300 ppm, 200 ppm, or 100 ppm.

In embodiments, preparing a PAG-based lubricant comprises producing a lubricant composition or lubricant basefluid having a kinematic viscosity of at least 30 cSt, at least 20 cSt, or at least 10 cSt and/or a viscosity index of at least 150, at least 120 or at least 100. In embodiments, preparing a lubricant composition comprises providing a lubricant that, when added to a refrigerant at a concentration of 50, 40, 30, 20, 10, or 5 wt % or less, provides a refrigeration composition that exhibits a single liquid phase at temperatures between about −40° and about 10° C., between −50° and about 20° C. and/or between −60° C. and 30° C.

### EXAMPLES

### Example 1

### Miscibility of Inventive Basefluid in 1234yf Refrigerant Vs. Various Structures of PAG Basefluid

The miscibility of PAG lubricant basefluids with refrigerant HFO-1234yf at weight percent lubricant concentrations of 0 to 50 wt % was determined in accordance with ANSI/ASHRAE 86-1994 standard “Methods of Testing the Floc. Point of Refrigeration Grade Oils.” The lubricant and refrigerant were added gravimetrically to heavy-walled glass test tubes. The tubes were then sealed. Phase separation was detected by visual observation as the solution temperature was slowly changed from room temperature (20° C.) to −60° C. (cooling cycle) and from room temperature to +95° C. (heating cycle). The temperature at which phase separation occurs (i.e. one phase separating into two) were observed on both the cooling and heating cycle, the lowest value at a given wt % lubricant concentration being recorded as the separation temperature (Critical Solution temperature, CST).

The results are presented in Table 1. In this example, Sample 1 was a PAG basefluid having the formula RX(R^{b}O)_{y}R^{c}, wherein R is a C3 alkyl group; X is O; R^{b} is a C3 alkylene group; R^{c} is the same as R; and y is an integer resulting in a basefluid viscosity of 46 cSt at 40° C.; Sample 2 was a PAG basefluid having the formula RX(R^{b}O)_{y}R^{c}, wherein R is a C4 alkyl group; X is O; R^{b} is a C3 alkylene group; R^{c} is H; and y is an integer resulting in a basefluid viscosity of 46 cSt at 40° C.; Sample 3 was a PAG basefluid having the formula RX(R^{b}O)YR^{c}, wherein R is a C14 substituent comprising a heterocyclic ring in which the heteroatom is oxygen; X is O; R^{b} is a C3 alkylene group; R^{c} is a C3 alkyl group; and y is an integer resulting in a basefluid viscosity of 46 cSt at 40° C.; Sample 4 was a PAG basefluid having the formula RX(R^{a}O)ₓ(R^{b}O)_{y}R^{c}, wherein R is a C14 substituent comprising a heterocyclic ring in which the heteroatom is oxygen; X is O; R^{a} is a C2 alkylene group; R^{b} is a C3 alkylene group; R^{c} is a C3 alkyl group; and x and y are integers resulting in an equal wt % content of (R^{a}O) and (R^{b}O) and also a basefluid viscosity of 46 cSt at 40° C.; and Sample 5 was a PAG basefluid having the formula RX(R^{a}O)ₓ(R^{b}O)_{y}R^{c}, wherein R is a C3 alkyl group; X is O; R^{a} is a C2 alkylene group; R^{b} is a C3 alkylene group; R^{c} is a C3 alkyl group; and x and y are integers resulting in an equal wt % content of (R^{a}O) and (R^{b}O) and also a basefluid viscosity of 46 cSt at 40° C.

TABLE 1
Miscibility data for PAGs with HFO 1234yf

| Composition | Separation | Separation | Separation | Separation | Separation |
|---|---|---|---|---|---|
| Weight % | Tem- | Tem- | Tem- | Tem- | Tem- |
| Lubricant in | perature | perature | perature | perature | perature |
| 1234yf | Sample 1 | Sample 2 | Sample 3 | Sample 4 | Sample 5 |
| refrigerant | (° C.) | (° C.) | (° C.) | (° C.) | (° C.) |
| 1.8 | 60.0 | — | — | — | — |
| 4.0 | 42.5 | 24.0 | 42.0 | — | — |
| 7.0 | 33.0 | 8.0 | 34.0 | — | — |
| 7.5 | 32.5 | — | — | — | — |
| 10.0 | 30.0 | 2.0 | 15.0 | — | — |
| 18.0 | 30.0 | — | — | — | — |
| 20.0 | 30.0 | 4.0 | 16.0 | −9.5 | −8.0 |
| 25.9 | 32.5 | — | — | — | — |
| 30.0 | 33.5 | 11.0 | 18.0 | — | — |
| 40.4 | 45.0 | — | — | — | |
| 50.0 | One phase | One phase | One phase | — | — |

Preliminary screening indicated a typical lowest separation temperature for PAG basefluids at around 10-20 wt % lubricant, therefore for some (less suitable) samples a nominal value at 20.0 wt % lubricant is reported for comparison purposes.

Comparative data in Table 1 indicates that an inventive PAG basefluid of the type of Sample 1 allows a minimum CST of 30.0° C. to be achieved across the lubricant concentration range 0 to 50.0 wt %, with this minimum typically observable at the 10.0 to 20.0 wt % lubricant concentration range.

### Example 2

### Chemical Stability of Inventive Basefluid and Additive Composition in 1234yf Refrigerant

The chemical stability of lubricant samples in the presence of HFO-1234yf was tested in accordance with ANSI/ASHRAE 97-1999 standard (Sealed Glass Tube Method to Test the Chemical Stability of Materials for Use Within Refrigerant Systems). The experimental conditions included a temperature of 175° C., a test duration of 14 days, and a moisture content as stated. Copper, aluminum and steel metal coupons were immersed in the test samples according to the standard procedure.

In Example 2, Sample 1b had the formula RX(R^{b}O)_{y}R^{c}, wherein R is a C3 alkyl group; X is O; R^{b} is a C3 alkylene group; R^{c} is the same as R; and y is an integer resulting in a basefluid viscosity of 46 cSt at 40° C. Sample 1b also comprised the antioxidants benzenepropanoic acid, 3,5-bis(1,1-dimethyl-100% ethyl)-4-hydroxy, branched alkyl esters, and benzenamine, N-phenyl, reaction products with 2,4,4-trimethylpentene, the corrosion inhibitor isomeric mixture of N,N-bis(2-ethylhexyl)-4-methyl-1H-benzotriazole-1-methylamine and N,N-bis(2-ethylhexyl)-5-methyl-1H-benzotriazole-1-methylamine, and the extreme pressure (EP)/antiwear additive C11-C14 branched alkyl amines, monohexyl and dihexyl phosphates. Sample 2b had the formula RX(R^{b}O)_{y}R^{c}, wherein R is a C4 alkyl group; X is O; R^{b} is a C3 alkylene group; R^{c} is H; and y is an integer resulting in a basefluid viscosity of 46 cSt at 40° C. Sample 2b also comprised the antioxidants benzenepropanoic acid, 3,5-bis(1,1-dimethyl-100% ethyl)-4-hydroxy, branched alkyl esters, and benzenamine, N-phenyl, reaction products with 2,4,4-trimethylpentene, the corrosion inhibitor isomeric mixture of N,N-bis(2-ethylhexyl)-4-methyl-1H-benzotriazole-1-methylamine and N,N-bis(2-ethylhexyl)-5-methyl-1H-benzotriazole-1-methylamine, and the EP/antiwear additive C11-C14 branched alkyl amines, monohexyl and dihexyl phosphates. Sample 3b had the formula RX(R^{b}O)_{y}R^{c}, wherein R is a C14 substituent comprising a heterocyclic ring in which the heteroatom is oxygen; X is O; R^{b} is a C3 alkylene group; R^{c} is a C3 alkyl group; and y is an integer resulting in a basefluid viscosity of 46 cSt at 40° C. Sample 3b also comprised the antioxidants benzenepropanoic acid, 3,5-bis(1,1-dimethyl-100% ethyl)-4-hydroxy, branched alkyl esters, and benzenamine, N-phenyl, reaction products with 2,4,4-trimethylpentene, the corrosion inhibitor isomeric mixture of N,N-bis(2-ethylhexyl)-4-methyl-1H-benzotriazole-1-methylamine and N,N-bis(2-ethylhexyl)-5-methyl-1H-benzotriazole-1-methylamine and the EP/antiwear additive C11-C14 branched alkyl amines, monohexyl and dihexyl phosphates. Sample 6 was a Comparative Sample having the formula RX(R^{b}O)_{y}R^{c}, wherein R is a C3 alkyl group; X is O; R^{b} is a C3 alkylene group; R^{c} is the same as R; and y is an integer resulting in a basefluid viscosity of 46 cSt at 40° C. Comparative Sample 6 also comprised tricresyl phosphate antioxidant (nominal type in usage in refrigeration oil applications), uninhibited with respect to corrosion inhibitors or EP/antiwear additives. Sample 7 had the formula RX(R^{b}O)_{y}R^{c}, wherein R is a C3 alkyl group; X is O; R^{b} is a C3 alkylene group; R^{c} is the same as R; and y is an integer resulting in a basefluid viscosity of 46 cSt at 40° C. Sample 7 also comprised the antioxidants benzenepropanoic acid, 3,5-bis(1,1-dimethyl-100% ethyl)-4-hydroxy, branched alkyl esters, and benzenamine, N-phenyl, reaction products with 2,4,4-trimethylpentene, the corrosion inhibitor isomeric mixture of N,N-bis(2-ethylhexyl)-4-methyl-1H-benzotriazole-1-methylamine and N,N-bis(2-ethylhexyl)-5-methyl-1H-benzotriazole-1-methylamine and the EP/antiwear additive C11-C14 branched alkyl amines, monohexyl and dihexyl phosphates, plus epoxide type acid scavengers 1-methyl-4-(2-methyloxiranyl)-7-oxabicyclo[4.1.0]heptane and p-tert-butylphenyl 1-(2,3-epoxy) propyl ether.

Results are presented in Table 2. The comparative data in Table 2 demonstrate that under standard conditions of test (175° C., 14 days, 1000 ppm moisture) the additives proposed for use with the inventive basefluid (selected based on miscibility property) provide acceptable levels of chemical stability as evidenced by an absence of coupon corrosion or significant oil degradation, and acceptable levels of post-test Total Acid Value and fluoride ions.

Comparison of Samples 1 and 7 (inventive basefluid types and additive combinations) indicates further improvement in chemical stability achievable by additional additive optimization wherein sample 7 was subjected to a more severe test condition allowing the partial inclusion of air in the sealed glass tubes, which will accelerate chemical instability.

TABLE 2
Results of Example 2

| | | | | | | Post-test | | | |
|---|---|---|---|---|---|---|---|---|---|
| | Pre-test | | | | | Total | | | |
| | Sample | Post test Visual Observations | | | | Acid | Post-test Ion | | |
| | Water | | | Fe | | Number | Chromatography | | |
| Sample | Content | Liquid Phase | Cu Coupon | Coupon | Al Coupon | mgKOH/g | Fluoride (ppm) | Organic Anion (ppm) | Other Ion (ppm) |
| 1b | 974 | Remains Clear, | Unch.¹ | Unch.¹ | Unch.¹ | 0.26 | 108 | 150 | 0 |
| | | Color 3.0 vs. 2.0 | | | | | | | |
| | | for Un-aged. No | | | | | | | |
| | | Deposit/Precipitate | | | | | | | |
| | 29,304 | Remains Clear, | Unch.¹ | Very | Unch.¹ | 0.19 | 94 | 455 | 0 |
| | | Color 3.0 vs. 2.0 | | slightly | | | | | |
| | | for Un-aged. No | | darker | | | | | |
| | | Deposit/Precipitate | | | | | | | |
| 2b | 1,105 | Lubricant Color | Unch.¹ | Unch.¹ | Unch.¹ | 0.19 | 110 | 744 | 0 |
| | | Slightly Darker, | | | | | | | |
| | | 2.5 vs. 2.0 for un- | | | | | | | |
| | | aged. No | | | | | | | |
| | | Deposit/Precipitate | | | | | | | |
| | 29,427 | Lubricant Color | Unch.¹ | Unch.¹ | Unch.¹ | 0.22 | 127 | 816 | 0 |
| | | Unchanged (2.0), | | | | | | | |
| | | No Deposit/ | | | | | | | |
| | | Precipitate | | | | | | | |
| 3b | 993 | Lubricant Color | Unch.¹ | Unch.¹ | Unch.¹ | 0.18 | 103 | 33 | 0 |
| | | Slightly Darker, | | | | | | | |
| | | 3.0 vs. 2.0 for Un- | | | | | | | |
| | | aged. No Deposit/ | | | | | | | |
| | | Precipitate | | | | | | | |
| | 30,000 | Slight Cloudiness, | Unch.¹ | Very | Unch.¹ | 0.13 | 66 | 716 | 0 |
| | | Color Slightly | | slightly | | | | | |
| | | Darker (2.5 vs. 2.0 | | darker | | | | | |
| | | for Un-aged), No | | | | | | | |
| | | Deposit/Precipitate | | | | | | | |
| 6 | 1050 | Color Slightly | Unch.¹ | Unch.¹ | Unch.¹ | 1.25 | 104 | 0 | 0 |
| | | Darker (2.5 vs. 2.0 | | | | | | | |
| | | for Un-aged), No | | | | | | | |
| | | Deposit/Precipitate | | | | | | | |
| | 29,819 | Color Slightly | Unch.¹ | Slightly | Unch.¹ | 0.31 | 38 | 0 | 0 |
| | | Darker (2.5 vs. 2.0 | | darker, | | | | | |
| | | for Un-aged), No | | rust | | | | | |
| | | Deposit/Precipitate | | spots | | | | | |
| | | | | evident | | | | | |
| 7* | 2000 | Color Slightly | Unch.¹ | Unch.¹ | Unch.¹ | 0.05 | — | — | — |
| | | Darker (2.5 vs. | | | | | | | |
| | | 2.0), No Deposit | | | | | | | |

¹Unchanged

### Example 3

### Electrical Resistivity as a Function of PAG Basefluid Purification

Consideration is given to various production quality related factors which are considered may impact on the electrical properties of PAGs. Theoretical chemistry principles applied to the chemical structure of PAGs relative to Polyol Ester typical structures (MPE, DPE, TMP, PE polyol types of the type routinely used in refrigeration circuits where electrical leakage to the lubricant requires consideration) does not identify inherent causes of differences in electrical resistivities of these two synthetic lubricant types.

POE lubricants are historically manufactured to low levels of residual acid, typically 0.01 mgKOH/g (as required for reaction completion) and low levels of moisture content, typically 50 ppm (as defined in accordance with ASHRAE 97 testing as required for chemical stability in refrigeration circuits).

It is proposed that PAG chemical structure is not in itself limiting with regard to achievable electrical properties, and that recent advances in PAG production and post-treatment techniques may enable PAG to be manufactured with electrical resistivity properties in accordance with the requirements for hybrid/electric compressors. This resistivity standard is not currently clearly identified within the automotive air-conditioning industry but is recognized to be of the order of 1×10¹² Ωcm.

Primary quality factors considered to potentially influence electrical property are moisture content, Total Acid Value and Residual ionic species (primarily K⁺/Na⁺).

In Example 3, Samples were dried to less than 30 ppm via nitrogen purging/vacuum application and neutralized using weak organic acid/base to produce dry, neutral samples. ICP analysis was utilized to determine residual Na⁺ and K⁺ levels. Samples for evaluating electrical resistivity as a function of water content were further standardized with a Total Acid Value content of 0.03 mgKOH/g, based on minimum TAN specification which may be adopted on a commercial scale. Samples for evaluating electrical resistivity as a function of TAN were further standardized with a moisture content of 50 ppm, the driest realistically reproducible for a PAG type lubricant.

Electrical resistivities of comparative samples were determined in accordance with IEC 247 (Measurement of relative Permittivity, Dielectric Dissipation Factor and D.C Resistivity of Insulating Liquids). All work undertaken utilized a lubricant like Sample 1, i.e. a PAG lubricant having the formula RX(R^{b}O)_{y}R^{c}, wherein R is a C3 alkyl group; X is O; R^{b} is a C3 alkylene group; R^{c} is the same as R; and y is an integer resulting in a basefluid viscosity of 46 cSt at 40° C.

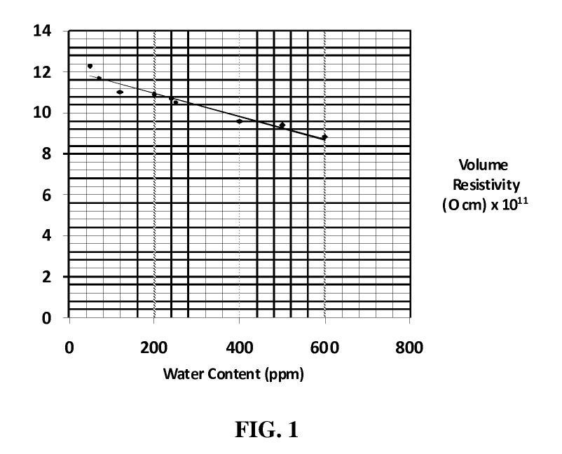

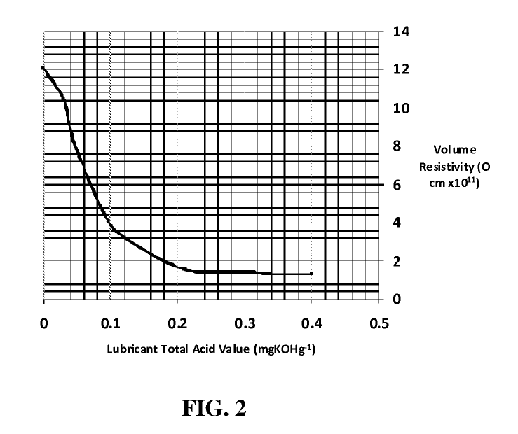

FIG. 1 is a plot of volume resistivity (in S2 cm) as a function of moisture content. In FIG. 1, the Total Acid Value for all samples was 0.03 mgKOH/g and alkali metal ion content was 30 ppm for all samples. FIG. 2 is a plot of volume resistivity (in S2 cm) as a function of Total Acid Value. In FIG. 2, the water content was 50 ppm for all samples and the alkali metal ion content was 30 ppm for all samples.

In order that a minimum volume resistivity at 20° C. of at least 1×10¹² ohm cm be achieved, it was determined that a purification process may be adopted such that the polyalkylene glycol based lubricant composition demonstrates a Total Acid Value of less than about 0.03 mgKOH/g, a cation content of less than about 30 ppm, and a moisture content of less than about 300 ppm.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

We claim:

1. A polyalkylene glycol lubricant basefluid for use with a fluoroalkene refrigerant, the polyalkylene glycol lubricant basefluid comprising a PAG having the formula:
RX(R^{a}O)ₓ(R^{b}O)_{y}R^{c},
wherein: R is selected from the group consisting of alkyl groups having from 1 to 10 carbon atoms, acyl groups having from 1 to 10 carbon atoms, aliphatic hydrocarbon groups having from 2 to 6 valencies, and substituents comprising a heterocyclic ring in which the one or more heteroatoms are oxygen; X is selected from the group consisting of O and S; R^{a} is a C2 alkylene group; R^{b} is a C3 alkylene group; R^{c} is the same as R or is an H; x and y are each independently 0 or an integer less than or equal to 100; and the sum of x+y is an integer in the range of from about 5 to about 100.

2. The polyalkylene glycol lubricant basefluid of claim 1 wherein x equals zero, the polyalkylene glycol lubricant being suitable for use in conjunction with fluoroalkene refrigerant in refrigeration/air-conditioning systems and comprising a PAG having the formula:
RX(R^{b}O)_{y}R^{c},
wherein R is selected from the group consisting of alkyl groups containing from 1 to 10 carbon atoms and aliphatic hydrocarbons; X is an oxygen atom; R^{b} is selected from the group consisting of alkylene groups containing 3 carbon atoms; R^{c} is selected from the group consisting of alkyl groups containing from 1 to 10 carbon atoms and aliphatic hydrocarbons; and y is an integer in the range of from about 5 to about 100.

3. The polyalkylene glycol lubricant basefluid of claim 2 wherein R, R^{c} or both are selected from alkyl groups containing from 1 to 3 carbon atoms.

4. The polyalkylene glycol lubricant basefluid of claim 2 having a kinematic viscosity of at least 30 cSt.

5. The polyalkylene glycol lubricant basefluid of claim 2 having a viscosity index of at least 150.

6. The polyalkylene glycol lubricant basefluid of claim 2, for use in conjunction with fluoroalkene refrigerants in motor-integrated compression type refrigeration and air conditioning systems, whereby as a result of purification techniques applied to the polyalkylene glycol, the polyalkylene glycol lubricant basefluid demonstrates a Total Acid Value of less than 0.03 mgKOH/g, a cation content of less than 30 ppm and a moisture content of less than 300 ppm.

7. The polyalkylene glycol lubricant basefluid of claim 6 having electrical properties desirable to ensure substantially no electrical leakage current is observed in motor-integrated compressors, the polyalkylene glycol lubricant basefluid exhibiting a minimum volume resistivity at 20° C. of 1×10¹² ohm cm.

8. A lubricant composition for use in conjunction with fluoroalkene refrigerant in refrigeration/air conditioning systems, the lubricant composition comprising the polyalkylene glycol lubricant basefluid of claim 2 and at least one additive.

9. The lubricant composition of claim 8 wherein the at least one additive is selected from antiwear or extreme pressure additives, antioxidants, corrosion inhibitors and acid scavengers.

10. The lubricant composition of claim 9 comprising at least one antioxidant selected from the group consisting of benzenepropanoic acid, 3,5-bis(1,1-dimethyl-100% ethyl)-4-hydroxy, C7-C9 branched alkyl esters, and benzenamine, N-phenyl, reaction products with 2,4,4-trimethylpentene.

11. The lubricant composition of claim 9 comprising at least one corrosion inhibitor selected from the group consisting of isomeric mixtures of N,N-bis(2-ethylhexyl)-4-methyl-1H-benzotriazole-1-methylamine and N,N-bis(2-ethylhexyl)-5-methyl-1H-benzotriazole-1-methaylamine.

12. The lubricant composition of claim 9 comprising an extreme pressure or antiwear additive selected from the group consisting of C11-14-branched alkyl amines, monohexyl and dihexyl phosphates.

13. The lubricant composition of claim 9 comprising an acid scavenger comprising an epoxide functionality.

14. A working fluid composition for use in a compression refrigeration, air conditioning or heat pump system, the working fluid composition comprising: a fluoroalkene containing 3 or 4 carbon atoms and at least one but no more than 2 double bonds; and an effective amount of lubricant to provide lubrication so that a mixture comprising the fluoroalkene and up to 10 wt % of the lubricant maintains one liquid phase at all temperatures in the range of from −60° C. to +29.5° C., and wherein said lubricant wholly or partly comprises the polyalkylene glycol lubricant basefluid of claim 2.

15. The working fluid composition of claim 14 comprising an effective amount of lubricant to provide lubrication so that a mixture comprising the fluoroalkene and up to 50 wt % of the lubricant maintains one liquid phase at all temperatures in the range of from −60° C. to +29.5° C.

16. A polyalkylene glycol based lubricant composition for use in motor-integrated compression type refrigeration/air conditioning systems, the polyalkylene based lubricant composition comprising the polyalkylene glycol lubricant basefluid of claim 1 wherein the polyalkylene glycol has been purified such that the purified polyalkylene glycol has a Total Acid Value of less than 0.03 mgKOH/g, a cation content of less than 30 ppm and a moisture content of less than 300 ppm and exhibits a minimum volume resistivity at 20° C. of 1×10¹² ohm cm, such that the lubricant exhibits substantially no electrical leakage current in motor-integrated compressors.

17. A working composition comprising:
a refrigerant selected from the group consisting of carbon dioxide (R744) and fluorocarbon 1,1,1,2-tetrafluoroethane (R134a); and
the polyalkylene glycol based lubricant composition of claim 16.

18. A polyalkylene glycol lubricant basefluid suitable for use with fluoroalkene refrigerants in refrigeration or air-conditioning systems, the polyalkylene glycol lubricant basefluid comprising a homopolymer of oxypropylene terminated by simple alkoxy groups containing from 1 to 10 carbon atoms.

19. The polyalkylene glycol lubricant basefluid of claim 18 wherein the homopolymer of oxypropylene is terminated by at least one methoxy group.

20. The polyalkylene glycol lubricant basefluid of claim 19 wherein each end of the homopolymer of oxypropylene is terminated by a methoxy group.

21. The polyalkylene glycol lubricant basefluid of claim 18 comprising from about 5 to about 100 oxypropylene units and having a kinematic viscosity of at least 30 cSt and a viscosity index of at least 150.

22. A lubricant composition suitable for use with fluoroalkene refrigerants in motor-integrated compression type refrigeration or air conditioning systems, the lubricant composition comprising the polyalkylene glycol lubricant basefluid of claim 18 and demonstrating a Total Acid Value of less than about 0.03 mgKOH/g, a cation content of less than about 30 ppm and a moisture content of less than about 300 ppm.

23. The lubricant composition of claim 22 that exhibits a minimum volume resistivity at 20° C. of at least 1×10¹² ohm cm.

24. A lubricant composition for use in conjunction with fluoroalkene refrigerant in refrigeration/air conditioning systems, the lubricant composition comprising
the polyalkylene glycol lubricant basefluid of claim 18; and
at least one additive selected from the group consisting of benzenepropanoic acid, 3,5-bis (1,1-dimethyl-100% ethyl)-4-hydroxy, C7-C9 branched alkyl esters, benzenamine, N-phenyl, reaction products with 2,4,4-trimethylpentene, isomeric mixtures of N,N-bis(2-ethylhexyl)-4-methyl-1H-benzotriazole-1-methylamine and N,N-bis(2-ethylhexyl)-5-methyl-1H-benzotriazole-1-methylamine, C11-14-branched alkyl amines, monohexyl and dihexyl phosphates and acid scavengers comprising an epoxide functionality.

25. A working fluid composition for use in compression refrigeration, air conditioning and heat pump systems comprising:
a fluoroalkene containing from 3 to 4 carbon atoms and at least one but no more than 2 double bonds; and
an effective amount of a lubricant composition to provide lubrication such that a mixture comprising the fluoroalkene and up to 50 wt % of the lubricant composition exhibits a single liquid phase at all temperatures between −60 and +29.5° C., wherein said lubricant composition wholly or partly comprises the polyalkylene glycol lubricant basefluid of claim 18.

26. A polyalkylene glycol based lubricant composition for use in motor-integrated compression type refrigeration and air conditioning systems with a refrigerant selected from the group consisting of carbon dioxide (R744) and fluorocarbon 1,1,1,2-tetrafluoroethane (R134a), the polyalkylene glycol based lubricant composition comprising a polyalkylene glycol purified such that the polyalkylene glycol based lubricant composition demonstrates a Total Acid Value of less than about 0.03 mgKOH/g, a cation content of less than about 30 ppm and a moisture content of less than about 300 ppm and exhibits a minimum volume resistivity at 20° C. of at least 1×10¹² ohm cm.

27. A method of operating a motor-integrated compressor of a refrigeration or air conditioning system with substantially no electrical leakage current, the method comprising:
operating the compressor with a working fluid composition comprising a refrigerant and the polyalkylene glycol based lubricant composition of claim 26.
